(19) United States
(12) Patent Application Publication
(10) Pub. No.: US 2023/0317988 A1
(43) Pub. Date: Oct. 5, 2023

(54) FUEL CELL SYSTEM

(71) Applicant: HONDA MOTOR CO., LTD., Tokyo (JP)

(72) Inventor: Tomoyuki INOUE, WAKO-SHI (JP)

(21) Appl. No.: 18/123,064

(22) Filed: Mar. 17, 2023

(30) Foreign Application Priority Data
Mar. 29, 2022 (JP) 2022-052685

(51) Int. Cl. H01M 8/0438; H01M 8/04492; H01M 8/04119; H01M 8/04992; H01M 8/04746; H01M 8/04537

(52) U.S. Cl. CPC H01M 8/04395; H01M 8/04492; H01M 8/04156; H01M 8/04992; H01M 8/04783; H01M 8/04619; H01M 2008/1095

(57) ABSTRACT

A control unit of a fuel cell system controls water drainage from a drain channel by controlling a drain valve based on a water accumulation state acquired by a water accumulation state acquisition part, and controls an amount of oxygen-containing gas supplied by an oxygen-containing gas supply part.

### CROSS-REFERENCE TO RELATED APPLICATIONS

This application is based upon and claims the benefit of priority from Japanese Patent Application No. 2022-052685 filed on Mar. 29, 2022, the contents of which are incorporated herein by reference.

### BACKGROUND OF THE INVENTION

### Field of the Invention

The present invention relates to a fuel cell system to be mounted on a moving object or the like.

### Description of the Related Art

In recent years, research and development have been conducted on fuel cells that contribute to energy efficiency in order to ensure that more people have access to affordable, reliable, sustainable and modern energy.

The fuel cell stack has a plurality of power generation cells stacked one another. The power generation cells generate electric power and produce water by reactions between the oxygen-containing gas and the fuel gas. In recent fuel cell systems, the interior of the fuel cell stack is kept at high humidity. For this reason, water tends to accumulate inside the fuel cell stack. The power generation cell deteriorates due to water immersion for a long time. If a large amount of water accumulates inside the fuel cell stack, it is preferable to discharge the water from the fuel cell stack.

JP 2016-081694 A discloses a method for discharging water from a fuel cell stack. The oxygen-containing gas is supplied to the fuel cell stack from a compressor. In this method, the rotational speed of the compressor is increased for discharging water from the fuel cell stack. According to this method, the pressure difference between the pressure inside the fuel cell stack and the pressure (atmospheric pressure) outside of the fuel cell stack (atmosphere) is increased, so that water can be pushed out of the fuel cell stack.

On the other hand, when the oxygen-containing gas is supplied to the inside of the fuel cell stack more than necessary, the electrolyte membrane of the power generation cell dries. The electrolyte membrane deteriorates due to drying. Therefore, it is not preferable to supply an excessive amount of oxygen-containing gas to the fuel cell stack. Many fuel cell systems have bypass flow paths that bypass the fuel cell stacks between the supply flow paths of the oxygen-containing gas and the discharge flow paths of the oxygen-containing off-gas. An excess oxygen-containing gas flowing through the supply flow paths may be directly discharged to the outside through the bypass flow paths and the discharge flow paths without passing through the fuel cell stacks.

### SUMMARY OF THE INVENTION

When the oxygen-containing gas is directly discharged to the discharge flow path via the bypass flow path, drying of the electrolyte membrane is suppressed, and an increase in pressure inside the fuel cell stack is also suppressed. Then, a pressure difference between the pressure inside the fuel cell stack and the atmospheric pressure is less likely to be made. Then, it becomes difficult to discharge water from the inside of the fuel cell stack. As a result, water is likely to accumulate inside the fuel cell stack.

An object of the present invention is to solve the aforementioned problem.

According to an aspect of the present invention, there is provided a fuel cell system including: a fuel cell stack configured to generate electric power using an oxygen-containing gas and a fuel gas; a supply passage through which the oxygen-containing gas to be supplied to the fuel cell stack flows; a discharge passage through which the oxygen-containing off-gas discharged from the fuel cell stack flows; an oxygen-containing gas supply unit provided in the supply passage and configured to supply the oxygen-containing gas to the fuel cell stack; a bypass flow path connecting the supply passage and the discharge passage; a bypass valve configured to adjust a communication state in the bypass flow path; a pressure adjustment unit provided in the discharge passage at a position downstream of a connecting point connected to the bypass flow path, the pressure adjustment unit being configured to make a pressure upstream of the connecting point higher than a pressure downstream of the connecting point; a drain channel connected to the fuel cell stack and configured to discharge water inside the fuel cell stack; a drain valve configured to adjust water drainage from the drain channel; a control unit configured to control an amount of the oxygen-containing gas to be supplied by the oxygen-containing gas supply unit and control the drain valve and the bypass valve; and a water accumulation state acquisition unit configured to acquire a water accumulation state inside the fuel cell stack, wherein on a basis of the water accumulation state acquired by the water accumulation state acquisition unit, the control unit controls the water drainage from the drain channel by the drain valve and the amount of oxygen-containing gas supplied by the oxygen-containing gas supply unit.

According to the present invention, water inside the fuel cell stack can be smoothly discharged to the outside by appropriately controlling the drain valve and the oxygen-containing gas supply unit.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of a fuel cell vehicle, into which a fuel cell system according to the present embodiment is incorporated;

FIG. 2 is a flowchart showing a procedure of water drainage process; and

FIG. 3 is a flowchart showing a procedure of pressure adjustment process.

### DETAILED DESCRIPTION OF THE INVENTION

### 1. Configuration of Fuel Cell System 12

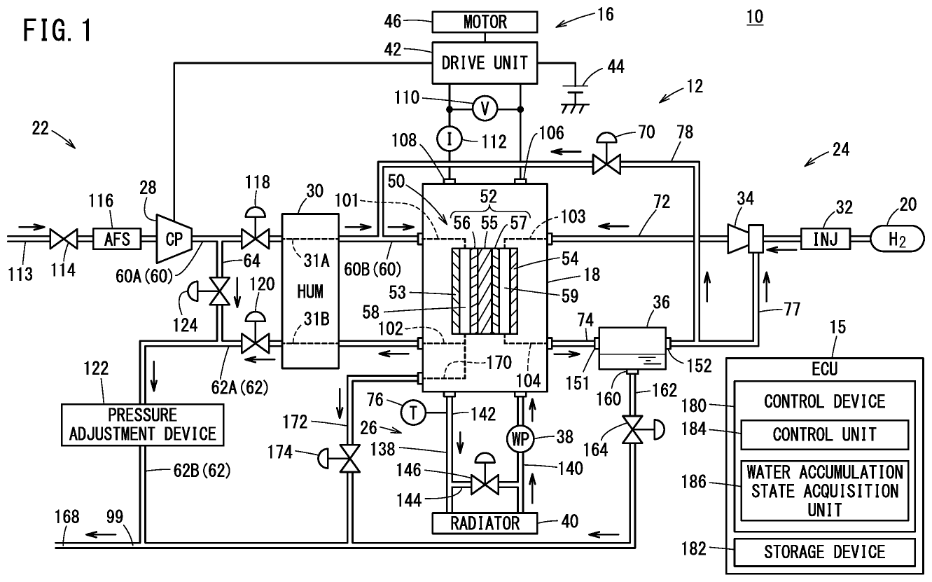

FIG. 1 is a schematic configuration diagram of a fuel cell vehicle 10, into which a fuel cell system 12 according to an embodiment of the present invention is incorporated. The fuel cell system 12 can be incorporated into any mobile objects such as automobiles, ships, aircrafts, and robots other than the fuel cell vehicle 10. Thus, the fuel cell system 12 contributes to energy efficiency.

The fuel cell vehicle 10 includes a fuel cell system 12, an ECU 15, and an output unit 16. The ECU 15 controls the entire fuel cell vehicle 10. The ECU 15 may be provided as two or more parts instead of one part. The output unit 16 is electrically connected to the fuel cell system 12.

The fuel cell system 12 includes a fuel cell stack 18, a hydrogen tank 20, an oxygen-containing gas supply device 22, a fuel gas supply device 24, and a coolant supply device (temperature adjusting device) 26.

The oxygen-containing gas supply device 22 includes a compressor (CP) (oxygen-containing gas supply unit) 28 and a humidifier (HUM) 30.

The fuel gas supply device 24 includes an injector (INJ) 32, an ejector 34, and a gas-liquid separator 36. The injector 32 may be replaced with a pressure reducing valve.

The coolant supply device 26 includes a coolant pump (WP) 38 and a radiator 40.

The output unit 16 includes a drive unit 42, a high-voltage power storage device 44, and a motor 46. Examples of a load of the drive unit 42 includes not only the motor 46, which is a main device, but also the compressor 28, which is an auxiliary device, and other vehicular auxiliary devices such as an air conditioner. The fuel cell vehicle 10 is driven by a driving force generated by the motor 46.

In the fuel cell stack 18, a plurality of power generation cells 50 are stacked. Each of the power generation cells 50 includes a membrane electrode assembly 52, and separators 53, 54 that sandwich the membrane electrode assembly 52.

The membrane electrode assembly 52 includes a solid polymer electrolyte membrane 55 (simply referred to also as electrolyte membrane 55), a cathode 56, and an anode 57. The electrolyte membrane 55 is formed by impregnating a thin membrane of perfluorosulfonic acid with water, for example. The cathode 56 and the anode 57 sandwich the electrolyte membrane 55. Each of the cathode 56 and the anode 57 has a gas diffusion layer made from carbon paper or the like. An electrode catalyst layer of a platinum alloy supported on porous carbon particles is coated uniformly on the surface of the gas diffusion layer. The electrode catalyst layer is formed on each surface of the electrolyte membrane 55.

A cathode flow field 58 is formed on a surface of one separator 53 facing the membrane electrode assembly 52. The cathode flow field 58 communicates with the oxygen-containing gas supply passage 101 and the oxygen-containing gas discharge passage 102.

An anode flow field 59 is formed on a surface of the other separator 54 facing the membrane electrode assembly 52. The anode flow field 59 communicates with the fuel gas supply passage 103 and the fuel gas discharge passage 104.

In the anode 57, by the fuel gas (hydrogen) being supplied, hydrogen ions are generated from hydrogen molecules by electrode reactions caused by catalyst, and the hydrogen ions pass through the solid polymer electrolyte membrane 55 and then move to the cathode 56, while electrons are released from hydrogen molecules.

Electrons released from hydrogen molecules move from the negative terminal 106 to the positive terminal 108 through the loads such as the drive unit 42, the motor 46, and the like, and then to the cathode 56.

At the cathode 56, by action of the catalyst, hydrogen ions and electrons react with oxygen contained in the oxygen-containing gas as supplied, to produce water.

A voltage sensor 110 is provided between wiring connecting the positive terminal 108 and the drive unit 42 and wiring connecting the negative terminal 106 and the drive unit 42. The voltage sensor 110 detects a voltage generated by the fuel cell stack 18. Further, a current sensor (power-generation-state acquisition unit) 112 that detects a current generated by the fuel cell stack 18 is provided in wiring connecting the positive terminal 108 and the drive unit 42.

The compressor 28 is constituted by a mechanical supercharger or the like driven by a motor (not shown). The electric power is supplied from the power storage device 44 to the motor of the compressor 28 through the drive unit 42. The compressor 28 has functions such as sucking and pressurizing air from an outside air intake hole 113, and supplying it to the fuel cell stack 18 through a humidifier 30.

The humidifier 30 has a flow path 31A and a flow path 31B. Air (oxygen-containing gas) heated to a high temperature and dried is discharged from the compressor 28 and flows through the flow path 31A. The exhaust gas discharged from the oxygen-containing gas discharge passage 102 of the fuel cell stack 18 flows through the flow path 31B.

Here, the exhaust gas is a humid oxygen-containing off-gas while a bleed valve 70 described later is closed. Further, while the bleed valve 70 is opened, the humid exhaust gas (off-gas) as a mixture of the humid oxygen-containing off-gas and a fuel off-gas passes therethrough.

The humidifier 30 has a function of humidifying the oxygen-containing gas supplied from the compressor 28. That is, the humidifier 30 transfers water contained in the exhaust gas (off-gas) flowing through the flow path 31B to the oxygen-containing gas flowing through the flow path 31A via an internally provided porous membrane to supply a humidified oxygen-containing gas to the fuel cell stack 18.

An oxygen-containing gas supply flow path (supply passage) 60 is provided between the outside air intake hole 113 and the oxygen-containing gas supply passage 101. The oxygen-containing gas supply flow path 60 includes an oxygen-containing gas supply flow path 60A on the upstream side and an oxygen-containing gas supply flow path 60B on the downstream side with a connecting point to a bypass flow path 64 described later interposed therebetween. The outside air intake hole 113, a shutoff valve 114, an air flow sensor (AFS) (supplied amount acquisition unit) 116, and the compressor 28 are provided in the oxygen-containing gas supply flow path 60A in this order from the upstream side to the downstream side. The oxygen-containing gas supply flow path 60B is provided with the supply-side stop valve 118 and the humidifier 30 in this order from the upstream side to the downstream side. The flow paths such as the oxygen-containing gas supply flow path 60 drawn by double lines are formed by pipes (the same applies to the following description).

The shut-off valve 114 is opened to allow and close to shut off intake of the air into the oxygen-containing gas supply flow path 60.

The air flow sensor 116 measures a flow rate of the oxygen-containing gas supplied to the fuel cell stack 18 through the compressor 28.

The supply-side stop valve 118 opens and closes the oxygen-containing gas supply flow path 60A.

An oxygen-containing gas discharge flow path (discharge passage) 62 is provided between the oxygen-containing gas discharge passage 102 and the merged channel 99. The oxygen-containing gas discharge flow path 62 includes an oxygen-containing gas discharge flow path 62A on the upstream side and an oxygen-containing gas discharge flow path 62B on the downstream side with a connecting point to the bypass flow path 64 described later interposed therebetween. In the oxygen-containing gas discharge flow path 62A, the humidifier 30 and the discharge-side stop valve 120 are provided in this order from the upstream side to the downstream side. The discharge-side stop valve 120 also functions as a back pressure valve. A pressure adjustment device (pressure adjustment unit) 122 is provided in the oxygen-containing gas discharge flow path 62B.

The pressure adjustment device 122 is a device that makes an upstream pressure higher than a downstream pressure. The pressure adjustment device 122 may be an orifice plate which is formed to have an opening smaller than the opening of the oxygen-containing gas discharge flow path 62B. Alternatively, the pressure adjustment device 122 may be a flow control valve whose opening degree is adjustable so that the opening of the flow control valve is smaller than the opening of the oxygen-containing gas discharge flow path 62B. The pressure adjustment device 122 is provided downstream of the discharge-side stop valve 120. Thus, even when the discharge-side stop valve 120 is opened during power generation operation of the fuel cell stack 18, the pressure inside the fuel cell stack 18 can be increased. Further, according to the pressure adjustment device 122, it is possible to increase the water content of the oxygen-containing gas as compared to a case where the pressure adjustment device 122 is not provided. Therefore, according to the pressure adjustment device 122, it is possible to suppress drying of the electrolyte membrane 55.

The bypass flow path 64 is provided between an intake of the supply-side stop valve 118 and an outlet of the discharge-side stop valve 120. The bypass flow path 64 connects the oxygen-containing gas supply flow path 60 and the oxygen-containing gas discharge flow path 62. The bypass flow path 64 is provided with a bypass valve 124 that opens and closes the bypass flow path 64. The bypass valve 124 adjusts the flow rate of the oxygen-containing gas bypassing the fuel cell stack 18.

The hydrogen tank 20 is a container including a solenoid shut-off valve, and compresses highly pure hydrogen under high pressure, and stores the compressed hydrogen.

The fuel gas discharged from the hydrogen tank 20 flows through the injector 32 and the ejector 34 that are disposed on a fuel supply flow path 72, and is then supplied to an inlet of the anode flow field 59 of the fuel cell stack 18 through a fuel gas supply passage 103.

An outlet of the anode flow field 59 is connected to a gas supply hole 151 of the gas-liquid separator 36 through a fuel gas discharge passage 104 and a fuel off-gas flow path 74. The fuel off-gas, which is a hydrogen-containing gas, is supplied from the anode flow field 59 to the gas-liquid separator 36.

The gas-liquid separator 36 separates the fuel off-gas into gaseous components and liquid components (liquid water). The gas component of the fuel off-gas (fuel exhaust gas) is discharged from a gas discharge hole 152 of the gas-liquid separator 36 and supplied to an intake of the ejector 34 through a circulation flow path 77. On the other hand, when the bleed valve 70 is opened, the fuel off-gas is also supplied to the oxygen-containing gas supply flow path 60B via the connecting flow path 78 and the bleed valve 70.

The liquid component of the fuel exhaust gas flows from the liquid discharge hole 160 of the gas-liquid separator 36 to the first drain channel 162 provided with a first drain valve 164 as the second on-off valve, is mixed with the exhaust gas discharged from the oxygen-containing gas discharge flow path 62B, and is discharged to the outside air through the merged channel 99 and the outlet 168.

A part of the fuel off-gas (hydrogen-containing gas) is discharged to the first drain channel 162 together with the liquid component. In order to dilute the hydrogen gas in the fuel off-gas before discharging it to the outside, a part of the oxygen-containing gas discharged from the compressor 28 is supplied to the oxygen-containing gas discharge flow path 62B through the bypass flow path 64.

The circulation flow path 77 and the oxygen-containing gas supply flow path 60B are connected by the connection flow path 78. The connection flow path 78 is provided with the bleed valve 70. When the bleed valve 70 is opened, the fuel off-gas discharged from the fuel cell stack 18 flows to the cathode flow field 58 through the fuel off-gas flow path 74, the gas-liquid separator 36, the circulation flow path 77, the connecting flow path 78, the oxygen-containing gas supply flow path 60B, and the oxygen-containing gas supply passage 101.

The fuel gas in the fuel off-gas flowing through the cathode flow field 58 is ionized into hydrogen ions by catalytic reactions at the cathode 56, and the hydrogen ions react with the oxygen-containing gas to produce water. The remaining unreacted fuel off-gas (composed of nitrogen gas and a small amount of unreacted hydrogen gas) is discharged from the fuel cell stack 18 as the oxygen-containing off-gas, and flows through the oxygen-containing gas discharge flow path 62.

The oxygen-containing off-gas (including the unreacted remaining fuel off-gas) flowing through the oxygen-containing gas discharge flow path 62 is mixed with the oxygen-containing gas supplied through the bypass flow path 64. In this way, the fuel off-gas (including the fuel gas) in the oxygen-containing off-gas is diluted so that the resulting oxygen-containing off-gas, in which the concentration of the fuel off-gas (including the fuel gas) is lowered, flows through the oxygen-containing gas discharge flow path 62B.

The oxygen-containing gas discharge flow path 62B merges with the first drain channel 162. The oxygen-containing gas discharge flow path 62B and the first drain channel 162 communicate with the merged channel 99.

The fuel cell stack 18 is provided with a drain outlet 170. The drain outlet 170 is connected to the cathode flow field 58 and the oxygen-containing gas discharge passage 102. The drain outlet 170 is provided to directly drain water accumulating inside the fuel cell stack 18. The drain outlet 170 is positioned in a lower part of the fuel cell stack 18 at least below the oxygen-containing gas discharge passage 102. The second drain cannel (drain channel) 172 communicates the drain outlet 170 with the first drain channel 162. With this structure, water produced inside the fuel cell stack 18 can be discharged from the drain outlet 170 to the outside via the second drain channel 172, the first drain channel 162, the merged channel 99, and the outlet 168.

A second drain valve (drain valve) 174 is provided in the second drain channel 172. The second drain valve 174 adjusts water drainage from the second drain channel 172. When the second drain valve 174 is in the open state, water can be discharged from the inside to the outside of the fuel cell stack 18. When the second drain valve 174 is in the closed state, water cannot be discharged from the inside to the outside of the fuel cell stack 18.

In the merged channel 99, the fuel gas in the mixed fluid of the liquid water and the fuel off-gas discharged from the first drain channel 162 is diluted by the oxygen-containing off-gas from the oxygen-containing gas discharge flow path 62B. The diluted gas is discharged to the outside of the fuel cell vehicle 10 through the outlet 168.

The coolant supply device 26 includes a coolant flow path 138 through which the coolant flows. The coolant flow path 138 includes a coolant supply flow path 140, a coolant discharge flow path 142, and a coolant bypass flow path 144. The coolant supply flow path 140 supplies a coolant to the fuel cell stack 18. The coolant discharge flow path 142 discharges the coolant from the fuel cell stack 18. The radiator 40 is connected to the coolant supply flow path 140 and the coolant discharge flow path 142. The radiator 40 cools the coolant. The coolant supply flow path 140 is provided with the coolant pump 38. The coolant bypass flow path 144 is connected to the coolant supply flow path 140 and the coolant discharge flow path 142. The coolant bypass flow path 144 is connected to the coolant supply flow path 140 between the coolant pump 38 and the radiator 40. The coolant bypass flow path 144 is provided with a coolant bypass valve 146 that opens and closes the coolant bypass flow path 144.

The temperature sensor (temperature acquisition device) 76 is provided in the coolant discharge flow path 142. The temperature of the coolant flowing through the coolant discharge flow path 142 correlates with the temperature inside the fuel cell stack 18. In the present embodiment, the temperature of the coolant (coolant outlet temperature) detected by the temperature sensor 76 is detected (acquired) as the temperature inside the fuel cell stack 18.

The ECU 15 includes a control device 180 and a storage device 182. The control device 180 includes a processing circuit. The processing circuit may be a processor such as a CPU or the like. The processing circuit may be an integrated circuit such as an ASIC, an FPGA, or the like. The processor is capable of executing various processes by executing programs stored in the storage device 182. At least a portion from among a plurality of processes may be performed by an electronic circuit including a discrete device.

The control device 180 controls the operation of the fuel cell system 12. For example, the control device 180 receives signals transmitted from various sensors. Based on the received signals, the control device 180 outputs control signals for controlling the valves, the injector 32, the compressor 28, the coolant pump 38, and the like. The valves, the injector 32, the compressor 28, the coolant pump 38, and the like operate in response to the control signals.

The control device 180, for example, a processor, functions as a control unit 184 and a water accumulation state acquisition unit 186 by executing programs. The control unit 184 executes control (water drainage control) for discharging water inside the fuel cell stack 18 to the outside. The water accumulation state acquisition unit 186 calculates (acquires) the water accumulation state inside the fuel cell stack 18. The water accumulation state is, for example, a water accumulation rate, an amount of water accumulation, or the like. In the present embodiment, the water accumulation state is acquired by calculation by the water accumulation state acquisition unit 186. Alternatively, the water accumulation state may be detected by a sensor provided in the fuel cell stack 18.

The storage device 182 includes a volatile memory and a non-volatile memory. Examples of the volatile memory include a RAM (Random Access Memory) or the like. The volatile memory is used as a working memory of the processor. In the volatile memory, data and the like required for carrying out processing or computations are temporarily stored therein. Examples of the nonvolatile memory include a ROM (Read Only Memory), a flash memory, and the like. Such a non-volatile memory is used as a storage memory. Programs, tables, and maps, and the like are stored in the non-volatile memory. At least part of the storage device 182 may be provided in the processor, the integrated circuit, etc. as described above.

### 2. Water Drainage Process

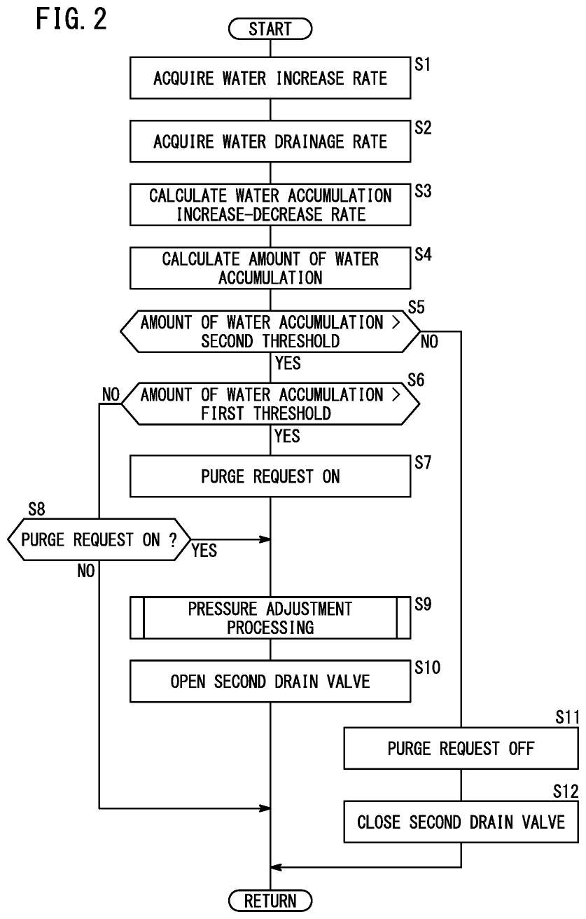

FIG. 2 is a flowchart showing a procedure of water drainage process. During the operation of the fuel cell system 12, the control device 180 executes the drainage process shown in FIG. 2 at a predetermined cycle.

In step S1, the water accumulation state acquisition unit 186 acquires a water increase rate. The amount of water produced inside the fuel cell stack 18 correlates with the amount of power generated by the fuel cell stack 18, for example, a generated current value. Here, the water accumulation state acquisition unit 186 acquires the detection value of the current sensor 112. The water accumulation state acquisition unit 186 acquires the water increase rate corresponding to the detection value of the current sensor 112 using a table (or a map) indicating the relationship between the generated current value and the water increase rate. This table (or map) is stored in the storage device 182. When the process of step S1 is completed, the process transitions to step S2.

In step S2, the water accumulation state acquisition unit 186 acquires a water drainage rate from the second drain channel 172. Here, the water accumulation state acquisition unit 186 acquires the measurement value of the air flow sensor 116. When the second drain valve 174 is opened, the water accumulation state acquisition unit 186 acquires the water drainage rate corresponding to the detection value of the current sensor 112 and the measurement value of the air flow sensor 116 by using a table (or a map) indicating the relationship among the current value, the amount of the oxygen-containing gas supplied and the water drainage rate. This table (or map) is stored in the storage device 182. When a purge request described later is OFF, that is, when the second drain valve 174 is closed, the water drainage rate is zero. When the process of step S2 is completed, the process transitions to step S3.

In step S3, the water accumulation state acquisition unit 186 calculates the latest water accumulation increase-decrease rate. The latest water accumulation increase-decrease rate corresponds to an increase rate or a decrease rate of water accumulation from a point in time of the previous calculation of the water accumulation to this point in time. Here, the water accumulation state acquisition unit 186 calculates the latest water accumulation increase-decrease rate by subtracting the water drainage rate acquired in step S2 from the water increase rate acquired in step S1. When the process of step S3 is completed, the process transitions to step S4.

In step S4, the water accumulation state acquisition unit 186 calculates the water accumulation at this point in time. The amount of water accumulated is an estimated value of the water accumulation inside the fuel cell stack 18. Here, the water accumulation state acquisition unit 186 multiplies the water accumulation increase-decrease rate acquired in step S3 by a predetermined cycle (cycle of the water drainage process). The water accumulation state acquisition unit 186 adds the multiplied value to the previous amount of water accumulated. In this way, the water accumulation state acquisition unit 186 estimates the latest water accumulation, that is, the amount of water accumulated inside the fuel cell stack 18 at this point in time. When the process of step S4 is completed, the process transitions to step S5.

In step S5, the control unit 184 compares the water accumulation calculated in step S4 with the second threshold. The second threshold is a threshold for determining whether or not to stop water drainage in progress. For example, the second threshold is set to zero in advance. When the water accumulation exceeds the second threshold (step S5: YES), the process proceeds to step S6. When the water accumulation is equal to or less than the second threshold (step S5: NO), the process proceeds to step S11.

When the process proceeds from step S5 to step S6, the control unit 184 compares the water accumulation calculated in step S4 with the first threshold. The first threshold is a threshold for determining whether or not to start water drainage not in progress. The first threshold is also the allowable amount of water inside the fuel cell stack 18. The first threshold is larger than the second threshold. When the water accumulation exceeds the first threshold (step S6: YES), the process proceeds to step S7. When the water accumulation is equal to or less than the first threshold (step S6: NO), the process proceeds to step S8.

When the process proceeds from step S6 to step S7, it is necessary to start water discharge. In step S7, the control unit 184 turns on the purge request. The purge request corresponds to a flag indicating whether or not the water drainage control should be executed. When the purge request is ON, the water drainage control should be executed. When the process of step S7 is completed, the process transitions to step S9.

When the process proceeds from step S6 to step S8, the control unit 184 determines whether or not the purge request is ON. Here, the control unit 184 determines whether or not the water drainage control is being executed by determining the state of the purge request. When the purge request is ON, that is, when the control unit 184 is executing the water drainage control and the water accumulation is decreasing (step S8: YES), the process proceeds to step S9. On the other hand, when the purge request is off, that is, when the control unit 184 is not executing the water drainage control (step S8: NO), the processing in this cycle ends.

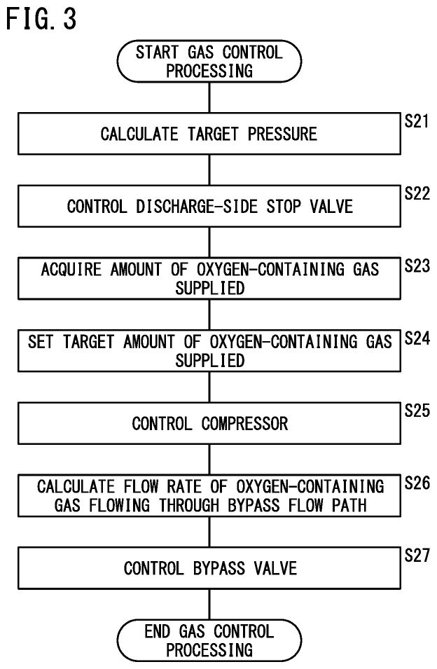

When the process proceeds to step S9 from step S7 or step S8, the control unit 184 performs the pressure adjustment process shown in FIG. 3. In order to discharge water from the inside of the fuel cell stack 18, the pressure inside the fuel cell stack 18 needs to be higher than the atmospheric pressure. For example, the pressure inside the fuel cell stack 18 can be increased by increasing the amount of the oxygen-containing gas supplied from the compressor 28. However, if the oxygen-containing gas is supplied in an excessive amount, the electrolyte membrane 55 dries. Therefore, it is preferable that the oxygen-containing gas in excess of the required amount is discharged from the bypass flow path 64 to the outside. Through the pressure adjustment process, the control unit 184 discharges the extra oxygen-containing gas from the bypass flow path 64 to the outside while maintaining the pressure inside the fuel cell stack 18 at a certain pressure or more. The pressure adjustment process will be described later. When the process of step S9 is completed, the process transitions to step S10.

In step S10, the control unit 184 opens the second drain valve 174. When the second drain valve 174 is closed, the control unit 184 transmits an open signal to the second drain valve 174. The second drain valve 174 opens the second drain channel 172 in response to the opening signal. On the other hand, when the second drain valve 174 is already open, the control unit 184 keeps the second drain valve 174 opened. When step S9 is executed, the processing of this cycle ends.

The water accumulation state acquisition unit 186 performs the processing of steps S1 to S4 in each cycle. On the other hand, after the water drainage control is started, the control unit 184 performs the processing of steps S5, S6, and S8 to S10 in each cycle until the amount of water in the fuel-cell stack 18 becomes equal to or less than the second threshold. When the amount of water in the fuel-cell stack 18 becomes equal to or less than the second threshold (step S5: NO), the process proceeds to step S11.

When the process proceeds from step S5 to step S11, the control unit 184 turns off the purge request. When the purge request is OFF, the control unit 184 may not need to perform the water drainage control. When the process of step S11 is completed, the process transitions to step S12.

In step S12, the control unit 184 closes the second drain valve 174. The control unit 184 transmits a closed signal to the second drain valve 174. The second drain valve 174 closes the second drain channel 172 in response to the closed signal. In this way, the control unit 184 ends the water drainage control. When step S12 is executed, the processing of this cycle ends.

By including the processing at step S5, the water drainage control can be ended at an appropriate timing. For example, if the water drainage control is ended when the water accumulation becomes equal to or less than the first threshold in step S6, water discharge is not sufficiently performed. Furthermore, the water drainage control are repeatedly started and ended in a short period of time. The processing at step S5 prevents such a problem.

### 3. Pressure Adjustment Process

FIG. 3 is a flowchart showing a procedure of pressure adjustment process. In step S9 of the drainage process shown in FIG. 2, the control device 180 executes the pressure adjustment process shown in FIG. 3.

In step S21, the control unit 184 calculates, as a target pressure, a pressure required for the cathode flow field 58 so that the oxygen-containing gas contains an amount of water that can prevent the electrolyte membrane 55 from drying. The target pressure is also a pressure at which water can be discharged from the inside to the outside of the fuel cell stack 18. In this case, the control unit 184 can calculate the target pressure based on the current atmospheric pressure detected by an atmospheric pressure sensor (not shown), the current temperature of the fuel cell stack 18 detected by the temperature sensor 76, and the target amount of power generated by the fuel cell stack 18.

The target amount of generated power may be supplied from a higher-level control device or the like, or may be calculated by the control unit 184. The target amount of generated power can be calculated on the basis, for example, of the amount of power required by a device that is driven by the power generated by the fuel cell stack 18. When the process of step S21 is completed, the process transitions to step S22.

In step S22, the control unit 184 controls the discharge-side stop valve 120 to set the opening degree of the discharge-side stop valve 120 to the opening degree corresponding to the target pressure calculated in step S21. In this case, the control unit 184 acquires the opening degree corresponding to the target pressure using a table or a relational expression indicating the relationship between the opening degree and the pressure. This table or relational expression is stored in the storage device 182. The control unit 184 decreases the opening degree as the target pressure increases.

During power generation operation of the fuel cell stack 18, the discharge-side stop valve 120 cannot be closed. Therefore, a predetermined lower limit opening degree is set in advance for the discharge-side stop valve 120. When the opening degree corresponding to the target pressure calculated in step S21 is lower than the lower limit opening degree of the discharge-side stop valve 120, the control unit 184 sets the opening degree of the discharge-side stop valve 120 to the lower limit opening degree. When the process of step S22 is completed, the process transitions to step S23.

In step S23, the control unit 184 acquires the amount of the oxygen-containing gas supplied correspondingly to the target pressure calculated in step S21 and the target amount of power generated by the fuel-cell stack 18. In this case, using a map indicating the relationship between the pressure with the amount of power generated and the amount of the oxygen-containing gas supplied, the control unit 184 acquires the amount of the oxygen-containing gas supplied.

The map is created in consideration of the amount of oxygen-containing gas required for power generation and the amount of oxygen-containing gas required for applying pressure to the cathode flow field 58, and is stored in the storage device 182. When the process of step S23 is completed, the process transitions to step S24.

In step S24, the control unit 184 sets, as the target amount of the oxygen-containing gas supplied to the fuel-cell stack 18, the amount of the oxygen-containing gas acquired in step S23 or the amount of the oxygen-containing gas required for the target amount of power generation (requisite supplied amount), whichever is larger.

At the opening degree of the discharge-side stop valve 120 set in step S22, the internal pressure in the oxygen-containing gas flow field raised by the discharge-side stop valve 120 may not reach the target pressure. In this case, the amount of the oxygen-containing gas acquired in step S23 becomes larger than the amount of oxygen-containing gas required for the target amount of power generation (requisite supplied amount). On the other hand, when the internal pressure of the oxygen-containing gas flow field reaches the target pressure, the amount of oxygen-containing gas required for the target amount of power generation becomes larger than the amount of oxygen-containing gas acquired in step S23. The internal pressure in the oxygen-containing gas flow field is the pressure in the cathode flow field 58. When the process of step S24 is completed, the process transitions to step S25.

In step S25, the control unit 184 controls the compressor 28 to change the flow rate of the oxygen-containing gas from the current flow rate to the target supplied amount. That is, the control unit 184 controls the compressor 28 to start supplying the oxygen-containing gas at the target supplied amount set in step S24. When the process of step S25 is completed, the process transitions to step S26.

In step S26, the control unit 184 calculates the flow rate of the oxygen-containing gas flowing through the bypass flow path 64 (the amount of gas supplied for bypassing). When the amount of the oxygen-containing gas acquired in step S23 is larger than the amount of the oxygen-containing gas required for the target amount of power generation (requisite supplied amount), there is an extra oxygen-containing gas unnecessary for power generation. In order to cause the extra oxygen-containing gas to flow through the bypass flow path 64, the control unit 184 calculates a difference between the amount of the oxygen-containing gas acquired in step S23 and the amount of the oxygen-containing gas required for the target amount of power generation. Specifically, the control unit 184 subtracts the amount of oxygen-containing gas from the target supplied amount.

When the amount of oxygen-containing gas required for the target amount of power generation is larger than the amount of oxygen-containing gas acquired in step S23, the control unit 184 calculates the amount of gas supplied for bypassing as zero. When the process of step S26 is completed, the process transitions to step S27.

In step S27, the control unit 184 controls the bypass valve 124 to set the opening degree of the bypass valve 124 to an opening degree corresponding to the amount of gas supplied for bypassing. In this case, the control unit 184 acquires the opening degree corresponding to the target pressure using a table or a relational expression indicating the relationship between the opening degree and the amount of gas. This table or relational expression is stored in the storage device 182. The control unit 184 increases the opening degree of the bypass valve 124 as the amount of gas supplied for bypassing increases.

When the amount of gas supplied for bypassing is zero, the control unit 184 sets the opening degree of the bypass valve 124 to zero. That is, the control unit 184 closes the bypass valve 124. Once the opening degree of the bypass valve 124 is set, the pressure adjustment process is ended.

As described above, when the internal pressure in the oxygen-containing gas flow field does not reach the target pressure, the control unit 184 intentionally causes the compressor 28 to supply the oxygen-containing gas in a target amount larger than the amount of the oxygen-containing gas required for the target amount of power generation. In this case, the control unit 184 supplies the extra oxygen-containing gas unnecessary for power generation to the pressure adjustment device 122 via the bypass flow path 64. As a result, the fuel cell stack 18 can be caused to generate the target amount of power while the pressure adjustment device 122 increases the internal pressure in the oxygen-containing gas flow field. That is, the internal pressure of the fuel cell stack 18 can be made higher than the atmospheric pressure. Therefore, water can be discharged from the inside to the outside of the fuel cell stack 18 in a state where the second drain valve 174 is opened. Furthermore, the electrolyte membrane 55 can be prevented from drying without decreasing the power generation efficiency.

4. Invention Obtained from Embodiment

The invention understood from the above embodiment will be described below.

The fuel cell system (12) according to the present embodiment includes: the fuel cell stack (18) configured to generate electric power using the oxygen-containing gas and the fuel gas; the supply passage (60) through which the oxygen-containing gas to be supplied to the fuel cell stack flows; the discharge passage (62) through which the oxygen-containing off-gas discharged from the fuel cell stack flows; the oxygen-containing gas supply unit (28) provided in the supply passage and configured to supply the oxygen-containing gas to the fuel cell stack; the bypass flow path (64) connecting the supply passage and the discharge passage; the bypass valve (124) configured to adjust the communication state in the bypass flow path; the pressure adjustment unit (122) provided in the discharge passage at a position downstream of a connecting point connected to the bypass flow path, the pressure adjustment unit being configured to make a pressure upstream of the connecting point higher than a pressure downstream of the connecting point; the drain channel (172) connected to the fuel cell stack and configured to discharge water inside the fuel cell stack; the drain valve (174) configured to adjust the water from the drain channel; the control unit (184) configured to control an amount of the oxygen-containing gas to be supplied by the oxygen-containing gas supply unit and control the drain valve and the bypass valve; and the water accumulation state acquisition unit (186) configured to acquire the water accumulation state inside the fuel cell stack, wherein on the basis of the water accumulation state acquired by the water accumulation state acquisition unit, the control unit controls the water drainage from the drain channel by the drain valve and the amount of oxygen-containing gas supplied by the oxygen-containing gas supply unit.

In the above-described configuration, the pressure adjustment unit may cause the pressure on the upstream side to be higher than the pressure on the downstream side. Thus, regardless of whether the bypass valve is opened or closed, the pressure inside the fuel cell stack can be made higher than the pressure outside the fuel cell stack (atmospheric pressure). Therefore, according to the above configuration, water in the fuel cell stack can be smoothly discharged to the outside by appropriately controlling the drain valve and the oxygen-containing gas supply unit.

The fuel cell system according to the present embodiment may further include: the power-generation-state acquisition unit (112) configured to acquire a power generation state of the fuel cell stack; and the supplied amount acquisition unit (116) configured to acquire an amount of the oxygen-containing gas supplied by the oxygen-containing gas supply unit. The water accumulation state acquisition unit may acquire the increased amount of water inside the fuel cell stack from the power generation state acquired by the power generation state acquisition unit, acquire the water drainage from the drain channel from the power generation state, the amount of the oxygen-containing gas acquired by the supplied amount acquisition unit, and the open or closed state of the drain valve, and acquire the water accumulation state from the increased amount of water and the water drainage, and in a case where the water accumulation state satisfies a predetermined condition, the control unit may control the drain valve to open and set a target supplied amount which is a target value of the amount of the oxygen-containing gas supplied by the oxygen-containing gas supply unit.

According to the above configuration, since the water accumulation state inside the fuel cell stack is grasped from the power generation state and the supply of the oxygen-containing gas, the water drainage control can be performed at an appropriate timing.

According to the present embodiment, the control unit may acquire from the power generation state the requisite supplied amount, which is the amount of the oxygen-containing gas required for power generation by the fuel cell stack, and set a target opening degree of the bypass valve based on a value obtained by subtracting the requisite supplied amount from the target supplied amount.

According to the above configuration, by controlling the opening degree of the bypass valve, the extra oxygen-containing gas unnecessary for power generation is discharged to the outside via the bypass flow path. Therefore, the pressure inside the fuel cell stack can be made higher than the pressure outside the fuel cell stack while suppressing the drying of the electrolyte membrane.

According to the present embodiment, the water accumulation state acquisition unit may acquire an amount of water accumulation as the water accumulation state, and the control unit may set the target supplied amount of the oxygen-containing gas by the oxygen-containing gas supply unit in a case where the amount of water accumulation acquired by the water accumulation state acquisition unit is equal to or larger than a first threshold, and execute water drainage control for discharging water inside the fuel cell stack, and after execution of the water drainage control, end the water drainage control in a case where the amount of water accumulation acquired by the water accumulation state acquisition unit is equal to or smaller than a second threshold, the second threshold being smaller than the first threshold.

With the arrangement mentioned above, the water drainage control can be ended at an appropriate timing.

The present invention is not limited to the above disclosure, and various modifications are possible without departing from the essence and gist of the present invention.

1. A fuel cell system comprising:
a fuel cell stack configured to generate electric power using an oxygen-containing gas and a fuel gas;
a supply passage through which the oxygen-containing gas flows to be supplied to the fuel cell stack;
a discharge passage through which the oxygen-containing off-gas discharged from the fuel cell stack flows;
an oxygen-containing gas supply unit provided in the supply passage and configured to supply the oxygen-containing gas to the fuel cell stack;
a bypass flow path connecting the supply passage and the discharge passage;
a bypass valve configured to adjust a communication state in the bypass flow path;
a pressure adjustment unit provided in the discharge passage at a position downstream of a connecting point connected to the bypass flow path, the pressure adjustment unit being configured to make a pressure upstream of the connecting point higher than a pressure downstream of the connecting point;
a drain channel connected to the fuel cell stack and configured to discharge water inside the fuel cell stack;
a drain valve configured to adjust water drainage from the drain channel; and
one or more processors that execute computer-executable instructions stored in a memory, wherein the one or more processors execute the computer-executable instructions to cause the fuel cell system to:
control an amount of the oxygen-containing gas supplied by the oxygen-containing gas supply unit and control the drain valve and the bypass valve; and
acquire a water accumulation state inside the fuel cell stack, and
on a basis of the water accumulation state, control the water drainage from the drain channel by the drain valve and the amount of oxygen-containing gas supplied by the oxygen-containing gas supply unit.

2. The fuel cell system according to claim 1, further comprising:
a power-generation-state acquisition unit configured to acquire a power generation state of the fuel cell stack; and
a supplied amount acquisition unit configured to acquire the amount of the oxygen-containing gas supplied by the oxygen-containing gas supply unit,
wherein the one or more processors cause the fuel cell system to:
acquire an increased amount of water inside the fuel cell stack, from the power generation state acquired by the power-generation-state acquisition unit,
acquire the water drainage from the drain channel, from the power generation state, the amount of the oxygen-containing gas acquired by the supplied amount acquisition unit, and an open or closed state of the drain valve,
acquire the water accumulation state from the increased amount of water and the water drainage, and
in a case where the water accumulation state satisfies a predetermined condition, control the drain valve to open and set a target supplied amount which is a target value of the amount of the oxygen-containing gas supplied by the oxygen-containing gas supply unit.

3. The fuel cell system according to claim 2, wherein the one or more processors cause the fuel cell system to:
acquire a requisite supplied amount, which is an amount of the oxygen-containing gas required for power generation by the fuel cell stack, based on the power generation state, and
set a target opening degree of the bypass valve based on a value obtained by subtracting the requisite supplied amount from the target supplied amount.

4. The fuel cell system according to claim 2, wherein the one or more processors cause the fuel cell system to:
acquire an amount of water accumulation as the water accumulation state,
set the target supplied amount of the oxygen-containing gas by the oxygen-containing gas supply unit in a case where the amount of water accumulation is equal to or larger than a first threshold, and execute water drainage control for discharging water inside the fuel cell stack, and
after execution of the water drainage control, end the water drainage control in a case where the amount of water accumulation is equal to or smaller than a second threshold, the second threshold being smaller than the first threshold.
